(19) United States
(12) Patent Application Publication
(10) Pub. No.: US 2026/0238307 A1
(43) Pub. Date: Aug. 13, 2026

(54) METHOD AND APPARATUS FOR WIRELESS COMMUNICATION

(71) Applicant: QUECTEL WIRELESS SOLUTIONS CO., LTD., Shanghai (CN)

(72) Inventors: Ling LYU, Frisco, TX (US); Zheng ZHAO, Shanghai (CN)

(21) Appl. No.: 19/637,138

(22) Filed: Apr. 2, 2026

Related U.S. Application Data
(63) Continuation of application No. PCT/CN2024/135346, filed on Nov. 28, 2024.

(51) Int. Cl. H04B 7/06; H04B 17/318

(52) U.S. Cl. CPC H04B 7/06952; H04B 7/0626; H04B 17/328

(57) ABSTRACT

Provided are a method and apparatus for wireless communication. The method includes: receiving, by a first device, a first reference signal, where the first reference signal is transmitted using a first beam set; and performing, by the first device, performance monitoring on a first model based on a measurement result of the first beam set, where the first reference signal corresponds to a first monitoring instance, and the first beam set is determined based on an inference beam set of the first model; and the first beam set includes all of beams in the inference beam set, or the first beam set includes part of beams in the inference beam set.

### CROSS-REFERENCE TO RELATED APPLICATIONS

This application is a continuation of International Application No. PCT/CN2024/135346, filed on Nov. 28, 2024, the disclosure of which is hereby incorporated by reference in its entirety.

### TECHNICAL FIELD

The present application relates to the field of communications technologies, and more specifically, to a method and apparatus for wireless communication.

### BACKGROUND

In some beam management scenarios, a terminal device may predict a downlink transmit beam by using a model and report the predicted downlink transmit beam to a network device. This model is required to be trained before the model can be used for inference and prediction. However, there may be a time interval between a training phase and an inference phase. If a transmission condition of a beam changes, the model may have an error during the inference phase. Therefore, how to perform performance monitoring on the model is a technical problem to be resolved urgently.

### SUMMARY

The present application provides a method and an apparatus for wireless communication. Various aspects of embodiments of the present application are described below.

According to a first aspect, a method for wireless communication is provided. The method includes: receiving, by a first device, a first reference signal, where the first reference signal is transmitted using a first beam set; and performing, by the first device, performance monitoring on a first model based on a measurement result of the first beam set, where the first reference signal corresponds to a first monitoring instance, and the first beam set is determined based on an inference beam set of the first model; and the first beam set includes all of beams in the inference beam set, or the first beam set includes part of beams in the inference beam set.

According to a second aspect, a method for wireless communication is provided. The method includes: transmitting, by a second device, a first reference signal, where the first reference signal is transmitted using a first beam set, where the first reference signal corresponds to a first monitoring instance, a measurement result of the first beam set is used for performing performance monitoring on a first model, and the first beam set is determined based on an inference beam set of the first model; and the first beam set includes all of beams in the inference beam set, or the first beam set includes part of beams in the inference beam set.

According to a third aspect, an apparatus for wireless communication is provided. The apparatus is a first device and includes: a transceiver unit, receiving a first reference signal, where the first reference signal is transmitted using a first beam set; and a processing unit, performing performance monitoring on a first model based on a measurement result of the first beam set, where the first reference signal corresponds to a first monitoring instance, and the first beam set is determined based on an inference beam set of the first model; and the first beam set includes all of beams in the inference beam set, or the first beam set includes part of beams in the inference beam set.

According to a fourth aspect, an apparatus for wireless communication is provided.

The apparatus is a second device, and includes: a transceiver unit, transmitting a first reference signal, where the first reference signal is transmitted using a first beam set, where the first reference signal corresponds to a first monitoring instance, a measurement result of the first beam set is used for performing performance monitoring on a first model, and the first beam set is determined based on an inference beam set of the first model; and the first beam set includes all of beams in the inference beam set, or the first beam set includes part of beams in the inference beam set.

According to a fifth aspect, a communications apparatus is provided. The communications apparatus includes a memory and a processor, where the memory is configured to store a program, and the processor is configured to invoke the program in the memory to execute the method according to the first aspect or the second aspect.

According to a sixth aspect, an apparatus is provided. The apparatus includes a processor, invoking a program from a memory to execute the method according to the first aspect or the second aspect.

According to a seventh aspect, a chip is provided. The chip includes a processor, invoking a program from a memory, to cause a device on which the chip is installed to execute the method according to the first aspect or the second aspect.

According to an eighth aspect, a computer-readable storage medium is provided, where the computer-readable storage medium stores a program, and the program causes a computer to execute the method according to the first aspect or the second aspect.

According to a ninth aspect, a computer program product is provided. The computer program product includes a program, where the program causes a computer to execute the method according to the first aspect or the second aspect.

According to a tenth aspect, a computer program is provided. The computer program causes a computer to execute the method according to the first aspect or the second aspect.

In embodiments of the present application, a first device (for example, a terminal device) may determine a first beam set based on an inference beam set of a first model, so as to perform performance monitoring on the first model based on a measurement result of the first beam set. The first beam set may be the inference beam set, or may be a subset of the inference beam set, so as to improve accuracy of the first model through real-time performance detection of inference beams.

### BRIEF DESCRIPTION OF THE DRAWINGS

FIG. 1 shows a wireless communications system to which embodiments of the present application are applied.

FIG. 2 is a schematic diagram of a model processing process to which embodiments of the present application are applied.

FIG. 3 is a schematic flowchart of a method for wireless communication according to an embodiment of the present application.

FIG. 4 is a schematic diagram of a possible implementation of the method shown in FIG. 3.

FIG. 5 is a schematic diagram of another possible implementation of the method shown in FIG. 3.

FIG. 6 is a schematic flowchart of a possible implementation of the method shown in FIG. 3.

FIG. 7 is a schematic diagram of a possible configuration manner of a first beam set shown in FIG. 3.

FIG. 8 is a schematic diagram of another possible configuration manner of a first beam set shown in FIG. 3.

FIG. 9 is a schematic diagram of still another possible configuration manner of a first beam set shown in FIG. 3.

FIG. 10 is a schematic diagram of still another possible configuration manner of a first beam set shown in FIG. 3.

FIG. 11 is a schematic diagram of still another possible configuration manner of a first beam set shown in FIG. 3.

FIG. 12 is a schematic diagram of a structure of an apparatus for wireless communication according to an embodiment of the present application.

FIG. 13 is a schematic diagram of a structure of another apparatus for wireless communication according to an embodiment of the present application.

FIG. 14 is a schematic diagram of a structure of an apparatus for wireless communication according to an embodiment of the present application.

### DETAILED DESCRIPTION OF THE EMBODIMENTS

The following describes the technical solutions in embodiments of the present application with reference to the accompanying drawings.

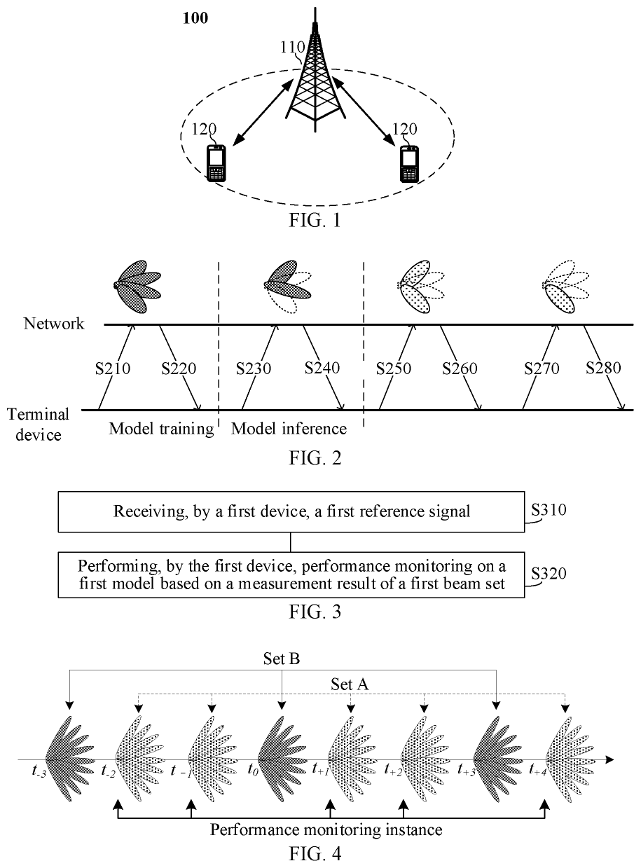

FIG. 1 is a schematic diagram of an architecture of a wireless communications system 100 to which embodiments of the present application are applied. As shown in FIG. 1, the wireless communications system 100 may include a network device 110 and terminal devices 120. The network device 110 may be a device that communicates with the terminal device 120. The network device 110 may provide communication coverage for a specific geographic area, and may communicate with a terminal device within the coverage.

FIG. 1 exemplarily shows one network device and two terminal devices. Optionally, the wireless communications system 100 may include a plurality of network devices, and another quantity of terminal devices may be included in coverage of each network device, which is not limited. That is, the wireless communications system may include one or more network devices, and each network device may support wireless communication of one or more terminal devices.

In embodiments of the present application, the communications system shown in FIG. 1 may further include other network entities such as a mobility management entity (mobility management entity, MME), an access and mobility management function (access and mobility management function, AMF), and a network controller, which is not limited in embodiments of the present application.

It should be understood that embodiments of the present application may be applied to various communications systems. For example, embodiments of the present application may be applied to a global system for mobile communications (global system of mobile communication, GSM), a code division multiple access (code division multiple access, CDMA) system, a wideband code division multiple access (wideband code division multiple access, WCDMA) system, a general packet radio service (general packet radio service, GPRS) system, a long term evolution (long term evolution, LTE) system, an advanced long term evolution (advanced long term evolution, LTE-A) system, a new radio (new radio, NR) system, an evolved system of an NR system, an LTE-based access to unlicensed spectrum (LTE-based access to unlicensed spectrum, LTE-U) system, an NR-based access to unlicensed spectrum (NR-based access to unlicensed spectrum, NR-U) system, a universal mobile telecommunications system (universal mobile telecommunication system, UMTS), a wireless local area network (wireless local area networks, WLAN) system, a wireless fidelity (wireless fidelity, WiFi) system, and a 5th-generation (5th-generation, 5G) communications system. Embodiments of the present application may be further applied to another communications system, for example, a future communications system such as a 6th-generation (6th-generation, 6G) mobile communications system or a satellite (satellite) communications system.

Conventional communications systems support a limited quantity of connections and are easy to implement. However, with development of communications technologies, a communications system may support not only conventional cellular communications but also one or more other types of communications. For example, the communications system may support one or more types of the following communication: device-to-device (device to device, D2D) communication, machine-to-machine (machine to machine, M2M) communication, machine type communication (machine type communication, MTC), enhanced machine type communication (enhanced MTC, eMTC), vehicle-to-vehicle (vehicle to vehicle, V2V) communication, vehicle-to-everything (vehicle to everything, V2X) communication, and the like. Embodiments of the present application may also be applied to a communications system that supports the foregoing communication manners.

The communications system in embodiments of the present application may be applied to a carrier aggregation (carrier aggregation, CA) scenario, a dual connectivity (dual connectivity, DC) scenario, or a standalone (standalone, SA) networking scenario.

The communications system in embodiments of the present application may be applied to an unlicensed spectrum. The unlicensed spectrum may also be considered as shared spectrum. Alternatively, the communications system in embodiments of the present application may be applied to licensed spectrum. The licensed spectrum may also be considered as dedicated spectrum.

Embodiments of the present application may be applied to a non-terrestrial network (non-terrestrial network, NTN) system. In an example, the NTN system may be a 4G-based NTN system, an NR-based NTN system, an NTN system based on an internet of things (internet of things, IoT), or an NTN system based on a narrow band internet of things (narrow band internet of things, NB-IoT).

The wireless communications system in embodiments of the present application may use the following resources to support wireless communication with one or more communications devices: time resources (for example, symbols, subslots, slots, subframes, and frames) or frequency resources (for example, subcarriers and carriers). Additionally, the wireless communications system may support wireless communication across various radio access technologies (radio access technology, RAT). The various radio access technologies include 3rd generation (3G) radio access technologies, 4th generation (4G) radio access technologies, 5th generation (5G) radio access technologies, and other suitable radio access technologies beyond 5G.

The terminal device in embodiments of the present application may also be referred to as user equipment (user equipment, UE), an access terminal, a subscriber unit, a subscriber station, a mobile site, a mobile station (mobile station, MS), a mobile terminal (mobile terminal, MT), a remote station, a remote terminal, a mobile device, a user terminal, a terminal, a user communications device, a wireless communications device, a user agent, a user apparatus, or the like.

In some embodiments, the terminal device in embodiments of the present application may be a device providing a user with voice and/or data connectivity and capable of connecting people, objects, and machines, such as a handheld device or a vehicle-mounted device having a wireless connection function. The terminal device in embodiments of the present application may be a mobile phone (mobile phone), a tablet computer (Pad), a notebook computer, a palmtop computer, a mobile Internet device (mobile internet device, MID), a wearable device, a virtual reality (virtual reality, VR) device, an augmented reality (augmented reality, AR) device, a wireless terminal in industrial control (industrial control), a wireless terminal in self driving (self driving), a wireless terminal in remote medical surgery (remote medical surgery), a wireless terminal in a smart grid (smart grid), a wireless terminal in transportation safety (transportation safety), a wireless terminal in a smart city (smart city), a wireless terminal in a smart home (smart home), or the like. Optionally, the UE may be configured to function as a base station. For example, the UE may function as a scheduling entity, which provides a sidelink signal between UEs in V2X, D2D, or the like. For example, a cellular phone and a vehicle communicate with each other by using a sidelink signal. A cellular phone and a smart home device communicate with each other, without relaying a communication signal through a base station.

In some embodiments, the terminal device may be a station (STATION, ST) in a WLAN. In some embodiments, the terminal device may be a cellular phone, a cordless phone, a session initiation protocol (session initiation protocol, SIP) phone, a wireless local loop (wireless local loop, WLL) station, a personal digital assistant (personal digital assistant, PDA) device, a handheld device with a wireless communication function, a computing device, or another processing device connected to a wireless modem, a vehicle-mounted device, a wearable device, a terminal device in a next-generation communications system (such as an NR system), a terminal device in a future evolved public land mobile network (public land mobile network, PLMN), or the like.

The network device in embodiments of the present application may be a device for communicating with the terminal device. The network device may also be referred to as an access network device or a wireless access network device. The network device may be, for example, a base station. The network device in embodiments of the present application may be a radio access network (radio access network, RAN) node (or device) that connects the terminal device to a wireless network. The base station may broadly cover various names in the following, or may be interchanged with the following names, for example, a NodeB (NodeB), an evolved NodeB (evolved NodeB, eNB), a next generation NodeB (next generation NodeB, gNB), a relay station, an access point, a transmitting and receiving point (transmitting and receiving point, TRP), a transmitting point (transmitting point, TP), a master eNodeB (MeNB), a secondary eNodeB (SeNB), a multi-standard radio (MSR) node, a home base station, a network controller, an access node, a wireless node, an access point (access point, AP), a transmission node, a transceiver node, a base band unit (base band unit, BBU), a remote radio unit (remote radio unit, RRU), an active antenna unit (active antenna unit, AAU), a remote radio head (remote radio head, RRH), a central unit (central unit, CU), a distributed unit (distributed unit, DU), a positioning node, a network communications device, or the like. The base station may be a macro base station, a micro base station, a relay node, a donor node, or the like, or a combination thereof. Alternatively, the base station may be a communications module, a modem, or a chip disposed in the device or the apparatus described above.

Alternatively, the base station may be a mobile switching center, a device that functions as a base station in D2D, V2X, or M2M communications, a network-side device in a 6G network, a device that functions as a base station in a future communications system, or the like. The base station may support networks of a same access technology or different access technologies. A specific technology and a specific device used by the network device are not limited in embodiments of the present application.

The base station may be stationary or mobile. For example, a helicopter or an unmanned aerial vehicle may be configured to function as a mobile base station, and one or more cells may move depending on a location of the mobile base station. In other examples, a helicopter or an unmanned aerial vehicle may be configured to function as a device in communication with another base station.

In some deployments, the network device in embodiments of the present application may be a CU or a DU, or the network device includes a CU and a DU. A gNB may further include an AAU.

The network device and the terminal device may be deployed on land, including being indoors or outdoors, handheld, or vehicle-mounted, may be deployed on a water surface, or may be deployed on a plane, a balloon, or a satellite in the air. In embodiments of the present application, a scenario of the network device and the terminal device is not limited.

It should be understood that all or a part of functions of the communications device in the present application may also be implemented by software functions running on hardware, or by virtualization functions instantiated on a platform (for example, a cloud platform).

In embodiments of the present application, the network device may provide a service for a cell. The terminal device communicates with the network device by using a transmission resource (for example, a frequency resource or a spectrum resource) used by the cell. The cell may be a cell corresponding to the network device (for example, a base station). The cell may belong to a macro station or may belong to a base station corresponding to a small cell (small cell). The small cell herein may include a metro cell (metro cell), a micro cell (micro cell), a pico cell (pico cell), a femto cell (femto cell), or the like. These small cells have characteristics of small coverage and low transmit power, and are suitable for providing a high-rate data transmission service.

It should be understood that a device having a communication function in a network/system in embodiments of the present application may be referred to as a communications device. The wireless communications system 100 shown in FIG. 1 is used as an example. The communications device may include a network device 110 and a terminal device 120 that have a communication function, and may further include another device in the wireless communications system 100, for example, another network entity such as a network controller or a mobility management entity, which is not limited in embodiments of the present application.

For example, the wireless communications system may include one or more network communications devices, such as the base station described above. Each network communications device, such as a base station, may support wireless communication of one or more user communications devices (for example, terminal devices).

For ease of understanding, some relevant technical knowledge related to embodiments of the present application is first described. The following related technologies, as optional solutions, may be randomly combined with the technical solutions of embodiments of the present application, all of which fall within the protection scope of embodiments of the present application. Embodiments of the present application include at least a part of the following content.

In a wireless communications system, a terminal device may obtain a beam (which may also be referred to as a spatial beam), to implement a wireless connection from the terminal device to a wireless network. For example, the terminal device may perform beam sweeping on an available beam transmitted by the wireless network, and measure attributes of the beam. The attributes of the beam are, for example, signal strength and signal quality. For example, after performing beam sweeping, the terminal device may further perform beam refinement, to achieve a group of potentially narrower beams used for wireless connection to the wireless network. The beam may not only implement wireless connection between the terminal device and the wireless network, but also implement high directional precision and high signal quality for wireless signal transmission between the terminal device and the wireless network.

With development of communication technologies, research on artificial intelligence (artificial intelligence, AI)/machine learning (machine learning, ML) technologies based on air interfaces of communications systems (for example, NR systems) becomes one of directions.

An objective of the research includes exploring how to enhance an advantage of the air interface. For example, related performance of the air interface may be enhanced by enhancing support for AI/ML algorithms. For another example, complexity and/or overheads of the air interface may be reduced by enhancing support for AI/ML algorithms.

Research on AI/ML technologies may also enhance functions related to beam management (beam management, BM). In an example, AI/ML enhancements related to beam management may support reduced overheads and reduced beam measurement and reporting delays. In an example, an AI/ML model may be applied to predict a beam, so as to improve transmission efficiency of an air interface.

A whole process of applying an AI/ML model for enhancement includes: model training, model inference, and model monitoring. In this process, the AI/ML model, after being trained, may generate a set of outputs based on a set of inputs. The inputs may be a set of beam measured values, and the outputs may be a set of beams different from or larger than the inputs.

In a model inference process, the AI/ML model may predict the best beam in a set of different or larger set of beams by using a set of beam measured values.

In some embodiments, the AI/ML model may be located on a terminal device side or the terminal device performs model training and/or model inference. The model may be referred to as a UE-side model (UE-side model). For example, the AI model is located at the terminal device, and training of the AI model and/or generation of the best beam by inference using the AI model may be performed at the terminal device or by the terminal device.

In an example, the terminal device may use a beam in a set B (Set B, also referred to as beam group B) as an input of the ML model. The ML model may predict the best beam in a set A (Set A, also referred to as beam group A), and the beam is not completely measured by the terminal device.

In the examples described above, the set B may be a beam group first measured by the terminal device, and may also be referred to as a training beam set. The set B may be a plurality of beams transmitted by a base station (for example, a gNB). The beams may correspond to different directions or angles, so as to cover a plurality of spatial directions. Each of the beams may further correspond to a measurement signal, which is used to obtain a measured value, such as a reference signal received power (reference signal received power, RSRP). The set B is used to provide the model with preliminary ambient information and channel conditions.

In the examples described above, the set A may be abeam group to be predicted during the inference phase, and may also be referred to as an inference beam set. The set A usually has a larger quantity of beams than set B, or may have more concentrated beam directions. The AI/ML model may predict the best beam in the set A by measuring the set B, to improve data transmission efficiency.

Optionally, beams in the set A and the set B may be in a same frequency range.

Selection of the set B may be given by the base station or determined by the terminal device itself. A relationship between the set A and the set B may be as follows: the set A is different from the set B (the set B is not a subset of the set A); or the set B is a subset of the set A (the set A is different from the set B); or the set A is the same as the set B. For the first two cases, the set B may be transmitted in both a measurement window and a prediction window, or may be transmitted only in a measurement window. For the last case, reference signal (reference signal, RS) transmission overheads may be reduced, and the set B used as measurement resources may be transmitted only in the measurement window.

Optionally, 64 or more beams may be used as a size of the beam set A. For future-oriented networks, a network device will be able to transmit 64 narrow beams with higher directivity. More narrow beams may allow sweeping of a larger set A, for example, a quantity of beams in the set A may be as large as 256.

Optionally, the network device may transmit a plurality of reference signals, such as a channel state information (channel state information, CSI) reference signal (CSI-reference signal, CSI-RS), and a synchronization signal block (synchronization signal block, SSB). It should be noted that the SSB may alternatively represent a synchronization signal/physical broadcast channel block (synchronization signal/physical broadcast channel block, SS/PBCH block). The SSB may include a primary synchronization signal (primary synchronization signal, PSS) and a secondary synchronization signal (secondary synchronization signal, SSS).

Optionally, the terminal device estimates channel quality of each beam by measuring RSRP of the received CSI-RS/SSS.

Optionally, in a model training process, the AI/ML model may adjust its weights by minimizing a loss function, so that the model can accurately predict the best beam in the set A from an RSRP measurement result of the set B.

In some embodiments, the AI/ML may be located on a network device (such as a base station) side, or the network device performs model training and/or model inference. The model may be referred to as a network-side model (NW-side model). For example, the AI model is located at the base station, and training of the AI model and/or generation of the best beam by inference using the AI model may be performed at the base station or by the base station.

In some embodiments, a network may completely control a data collection process of model training on the terminal device side, including starting, termination, and management of data collection and data transmission.

In an example, when a terminal device processes beams detected and measured from a wireless network by using an AI algorithm or ML to infer other beams that may have higher strength and/or higher quality, the terminal device is required to ensure consistency of the model between the training phase and the inference phase.

In comparison with other beam management technologies, by using beam management that supports the AI/VIL technology, the terminal device can experience a reduced delay, reduced overheads, reduced power consumption, and improved signal quality based on beam prediction.

For ease of understanding, the following describes an entire process of model processing on the terminal device side with reference to FIG. 2. FIG. 2 is illustrated from a perspective of interaction between a terminal device (for example, UE) side and a network (network, NW) side. Four beams on the network side are used as an example. It can be learned from FIG. 2 that the entire process may include a model training (model training) process, a model inference (model inference) process, and a reporting process. The model training process includes Step S210 and Step S220, and the model inference process includes Step S230 and Step S240.

Refer to FIG. 2. In Step S210, the terminal device reports training-related information (UE report training-related information).

In Step S220, the network side performs beam sweeping (beam scanning) based on four beams.

In Step S230, the terminal device reports inference-related information (UE report inference-related information).

In Step S240, the network side selects two beams from the four beams based on the reporting from the terminal device to perform beam sweeping.

In Step S250, the terminal device reports top K beams (top-K beam report).

In Step S260, the network side performs beam sweeping based on beams in the beam report. It can be learned from FIG. 2 that the two beams on which the network side performs beam sweeping in Step S260 may be different from the two beams on which the network side performs beam sweeping in Step S240.

In Step S270, the terminal device transmits a beam report (beam report), so that the network side determines a top beam.

In Step S280, the network side transmits a beam indication (beam indication) to the terminal device.

The foregoing describes, with reference to FIG. 2, a process of processing a model when the model is located on the terminal device side. To complete the entire process, the terminal device is further required to collect and analyze data, to perform model training. The model inference process is mainly used for beam prediction.

In related scenarios, the terminal device may support beam prediction in spatial domain and/or time domain, that is, BM-Case1 and/or BM-Case2. Based on AI/ML enhancements, the beam prediction in spatial domain (BM-Case1) and the beam prediction in time domain (BM-Case2) can reduce overheads of the terminal device and decrease delays in beam measurement and reporting.

BM-Case1 is spatial domain downlink (downlink, DL) beam prediction for the set A based on a measurement result of the set B. For BM-case 1, measurements of the set B (measurements based on Set B of beams) are used as a model input to predict a Top-1 beam/Top-K beams in the set A.

BM-Case2 is time domain DL beam prediction for the set A based on a historical measurement result of the set B. For BM-Case2, measurements of the beams in the set B at historical time instance(s) (measurements based on Set B of beams at historic time instance(s)) may be used as a model input, to predict time domain DL beams of the beams in the set A.

Prediction of DL Tx beams and prediction of DL Tx/Rx beams may also be used to evaluate prediction performance.

For BM-Case1 and BM-Case2, the terminal device may report a predicted result to the NW based on outputs of the terminal device-side model, or the NW may predict a Top-1 beam/Top-K beams based on a measurement report of the set B of the NW-side model.

The foregoing describes, with reference to FIG. 2, model training and model inference. To ensure correctness of model inference, a model monitoring process is also required to be performed.

AI/ML model monitoring in the model monitoring process is used for at least the following purposes: model activation, deactivation, selection, switching, rollback, and updating (including retraining). The model monitoring may also be referred to as a process of monitoring AI/ML model inference performance. There is definitely a time interval between training and inference of a model. When radio parameters/conditions change in the network, there is a high probability of occurrence of errors in an inference phase of the model, and therefore the model is required to be continuously modified and trained based on a result of the model monitoring.

For example, in some cases (before the model is used in a new radio environment/condition/parameter), model monitoring is required to be performed.

In the model monitoring process, performance of the AI/ML model may be monitored in three performance monitoring manners. Model monitoring may also be referred to as model surveillance or model surveillance. The three performance monitoring manners are respectively: performance monitoring on a terminal device (UE) side, performance monitoring on a network device (gNB) side, and hybrid performance monitoring on a terminal device side and a network device side.

In some scenarios, since the terminal device transmits an uplink beam, and the network device transmits a downlink beam, regardless of whether the model is located on the terminal device side, the network device side, or on both sides, the terminal device and the network device may perform model-based beam prediction and reporting.

For performance monitoring on the terminal device side, configuration/signalling from the network device to the terminal device may be used for performance monitoring. For performance monitoring on the network device side and hybrid performance monitoring, a configuration/signal from the network device to the terminal device may be used for measurement and/or reporting, so as to support performance detection of the model. In some embodiments, selection of a performance monitoring manner is related to a plurality of factors. These factors include but are not limited to: a device requirement, a model location, a service type, a communication scenario, and the like.

As previously described, there is a time interval between the training phase and the inference phase, and changes in radio parameters/conditions may cause errors in the inference phase. Therefore, to detect problems of the model in a timely manner, how to perform performance monitoring on the model is a technical problem to be resolved urgently.

In an example, selection of a data set for performing performance monitoring on the model and selection of a timing for model monitoring are very important. In other words, data collection for model performance monitoring is critical. This is because model monitoring may last for a long period of time, and may not end until beam management based on artificial intelligence is determined. Selection of a data set for performance surveillance is very important to ensure data collection efficiency and model monitoring accuracy. Therefore, how to select a data set for performance monitoring to perform efficient performance monitoring is an issue to be considered.

In view of this, an embodiment of the present application provides a method for wireless communication. In this method, a first beam set used for performing performance monitoring on a first model is determined based on an inference beam set of the first model. Since the first beam set is associated with the inference beam set, a first device (for example, the terminal device) may compare a predicted result with a measurement result of the inference beam set in a timely manner, to ensure accuracy of the model. It should be understood that, the first model in embodiments of the present application may be located on the terminal device side and/or the network device side.

The method for wireless communication proposed in embodiments of the present application is described in detail below with reference to FIG. 3. FIG. 3 is illustrated from a perspective of interaction between a first device and a second device.

The first device may be any type of communications device that supports model performance monitoring. In some embodiments, the first device may be a terminal device. For example, the first device may be a UE having a monitoring capability. For another example, the first device may include a terminal device and any type of processing device that supports performance monitoring. In some embodiments, the first device may be a network device. For example, the first device may be a base station.

In some embodiments, the first device supports function enhancements based on AI/ML operations. For example, the first device has a function of enhancing beam management and/or performing performance monitoring based on AI/ML operations.

In some embodiments, a first model is deployed on the first device, to implement beam prediction. When the second device is a network device, the first device performs DL beam prediction. When the second device is a terminal device, the first device performs sidelink beam prediction.

In an example, the first model is a model that supports an AI algorithm or ML, that is, the first model is an AI/ML model.

In an example, beam prediction implemented by the first model may be the BM-Case 1 or BM-Case2 described above, or may be another future beam prediction type, which is not limited herein.

In some embodiments, the first model is deployed on a first device side. The first model may not be located on the terminal device, but on a server communicating with the terminal device. For example, the first model is located on a server in direct communication with the terminal device.

The second device may be any network device in communication with the first device, or may be a terminal device in communication with the first device. When the first device is the terminal device and within coverage of the network device, the second device may be the network device. When the first device is the network device, the second device may be the terminal device in communication with the network device. In a sidelink communications system, when the first device communicates with another terminal device, the second device may be the another terminal device.

In some embodiments, the second device may monitor a process in which the first device processes the first model. For example, the second device may determine, based on a report transmitted by the first device, whether a current phase is the training phase or the inference phase of the first model, and may also determine a performance monitoring result of the first model based on the report transmitted by the first device. For another example, the second device may assist the first device in performing performance monitoring on the first model.

In some embodiments, the second device supports AI/ML operations. The first model may be deployed on a second device side.

In some embodiments, the second device may transmit a plurality of beams to the first device a plurality of times to facilitate measurement performed by the first device, and perform model training and model inference and/or model monitoring on the first model based on a measurement result.

In the embodiments described above, regardless of whether the first model is deployed on the terminal device side or the network device side, the first model may be one of a plurality of models deployed on the side. The plurality of models may be used to predict transmit beams from different scenarios or different beam transmission devices.

Referring to FIG. 3, in Step S310, the first device receives a first reference signal. The first reference signal is transmitted using a first beam set.

The first reference signal is used by the first device to perform performance monitoring on the first model. In an example, the first reference signal is used by the first device to collect a data set for performing performance monitoring on the first model. The data set may also be referred to as a performance monitoring set.

In some embodiments, the first reference signal is at least one of dedicated reference signals related to performance monitoring. The dedicated reference signal may also be referred to as a proprietary reference signal, a performance monitoring reference signal, or an auxiliary reference signal. In an example, the first reference signal may be one dedicated reference signal. In an example, the first reference signal may be a plurality of dedicated reference signals.

In an example, the dedicated reference signal may be used for determining a performance parameter of the first model. The performance parameter of the first model may also be referred to as a key performance indicator (key performance indicator, KPI) of performance monitoring. Optionally, the performance parameter of the first model may include prediction accuracy of the first model and/or a prediction error of the first model.

The first reference signal corresponds to a first monitoring instance. The first reference signal is used by the first device to perform performance monitoring on the first model at a time instance corresponding to the first device. Therefore, the first monitoring instance may also be referred to as a first performance monitoring instance (performance monitoring instance). In an embodiment, the first monitoring instance may be one or more of a plurality of monitoring instances for performing performance monitoring on the first model.

In some embodiments, the first monitoring instance may be one or more monitoring instances with a monitoring period of the first model. The monitoring period of the first model may be referred to as a first monitoring period. In an embodiment, the first monitoring period includes at least one monitoring instance. In the first monitoring period, the first device may receive and measure a reference signal, and then generate a monitoring report based on a measurement result.

In an example, the first monitoring period includes one monitoring instance, and the first device completes performance monitoring in the monitoring instance.

In an example, the first monitoring period includes a plurality of monitoring instances, and the plurality of monitoring instances correspond to reference signals at a plurality of time points, respectively.

In an example, the first monitoring period is equal to or less than a reporting period of monitoring reports. When the reporting period is greater than the first monitoring period, the first device may transmit a monitoring report after a plurality of times of monitoring.

The first reference signal is transmitted by using the first beam set. In other words, the first reference signal may be associated with the first beam set. The first beam set corresponds to the first monitoring instance. Therefore, a measurement result of the first beam set may be used as a monitoring data set for the first model. For example, some or all of beams in the first beam set may be used for transmitting the first reference signal.

The first beam set is determined based on an inference beam set of the first model, to ensure efficiency of collecting data and accuracy of monitoring the model. The inference beam set is, for example, the set A described above. When the first beam set is determined based on the inference beam set, the first device may directly compare the measurement result of the first beam set with an inference result of the first model. In an example, the first reference signal transmitted by using the first beam set may cover the entire set A or may cover only one subset of the set A, so that the first device can compare prediction regarding the set A (an inference target set) with actual measurement of a beam from the set A.

In some embodiments, the inference beam set of the first model may be determined based on the first model. That is, beams used for inference in the foregoing description and throughout this specification may be determined based on the first model. In an example, the inference beam set of the first model may be determined based on specific characteristics of the first model. The characteristics of the first model are, for example, characteristics related to model modeling and learning.

It should be noted that an inference beam may be referred to as a prediction beam, and the inference beam set may also be referred to as a prediction beam set.

In some embodiments, the first beam set includes all of beams in the inference beam set. When performance monitoring is performed on the first model, all performance monitoring reference signals corresponding to respective monitoring instances may be associated with the entire inference beam set. In this scenario, a performance monitoring data set collected by the first device is the same as a data set of the inference beam set.

In an embodiment, the first beam set is the inference beam set. When the first reference signal is transmitted using all of beams in the inference beam set (set A), the first device may obtain a measured value based on the set A, and accordingly define a monitoring process and metrics.

For ease of understanding, the method in which the first beam set is the inference beam set is described below by using an example with reference to FIG. 4. The set B in FIG. 4 is a training beam set of the first model, and the set A is the inference beam set of the first model. It may be learned from FIG. 4 that, on a time axis, the training beam set of the first model is transmitted at each of time instances [t₋₃, t₀, t₊₃], the inference beam set of the first model is transmitted at each of time instances [t₋₂, t₋₁, t₊₁, t₊₂, t₊₄], and the time instances [t₋₂, t₋₁, t₊₁, t₊₂, t₊₄] correspond to a plurality of performance monitoring instances.

Referring to FIG. 4, at each time instance corresponding to the inference beam set, the inference beam set is the same as the first beam set in the performance monitoring instance. Optionally, at each of time instances [t₋₂, t₋₁, t₊₁, t₊₂, t₊₄], a beam set of the first reference signal is the same as the inference beam set.

In some embodiments, the first beam set includes part of beams in the inference beam set. In some scenarios, measuring all of beams in the inference beam set may result in high complexity and resource consumption. For example, for a relatively large inference beam set (for example, 128 beams or more), measuring the whole inference beam set in each monitoring instance may result in excessive power consumption of the first device. Therefore, in each performance monitoring instance, measuring only part of beams in the inference beam set may reduce a measurement burden of the first device.

In an embodiment, part of beams in the inference beam set may form a first beam subset. In other words, in a case that the first beam set includes only part of beams in the inference beam set, the first beam set may also be referred to as a first beam subset of the inference beam set.

In the embodiments described above, in a case that the first beam set includes part of beams, the part of beams may be Top-K beams in the inference beam set.

In some embodiments, in a case that the first beam set includes part of beams in the inference beam set, a plurality of monitoring instances for performance monitoring may correspond to a plurality of beam subsets, respectively. The first beam subset may be any beam subset corresponding to the first reference signal in the plurality of beam subsets. In an example, the plurality of monitoring instances may include a first monitoring instance and a second monitoring instance, where the first monitoring instance corresponds to the first beam subset, and the second monitoring instance corresponds to a second beam subset.

In an example, the first beam subset and the second beam subset include at least one beam in common. That is, the first beam subset may share some beams with beam subsets corresponding to an monitoring instance. For example, both the first beam subset and the second beam subset include a beam 1 in the inference beam set, and the beam 1 may be a beam having relatively good signal quality in the inference beam set.

In an example, at least one beam is not included in both the first beam subset and the second beam subset. For example, the first beam subset and the second beam subset include no beams in common. For another example, the first beam subset and the second beam subset include some beams that are not in common.

In an example, the first beam subset is dynamically selected. That is, the plurality of beam subsets corresponding to the plurality of monitoring instances are dynamically determined, and monitoring beam subsets dynamically selected each time may share some beams.

In some embodiments, when the first device selects the first beam subset from the inference beam set, the first beam subset may be determined based on first information. The first information may include related information of some or all of beams in the inference beam set. The first information may include one or more of the following information: a beam priority of a beam in the inference beam set; historical performance data of a beam in the inference beam set; sensing quality of a beam in the inference beam set; a coverage area of a beam in the inference beam set; or a network load of a cell in which the first device is located.

In an example, the first beam subset may be determined based on priorities of some or all of beams in the inference beam set. That is, the first device may select the first beam subset based on beam priorities.

In an example, abeam priority of a beam in the inference beam set may be determined based on importance of the beam in a network, quality of the beam, and/or an amount of resources for monitoring the beam. When the beam priority is related to these factors, it may be ensured that the first device properly selects the first beam set. For example, system resources may be used for monitoring beams that have the greatest impact on network performance, thereby reducing a monitoring burden of less important beams.

In the examples described above, the importance of the beam in the network may be determined based on a quantity of users covered by the beam or a user level.

In the examples described above, the quality of the beam may include historical performance data. The historical performance data may include quality indicators such as historical RSRP of the beam and a signal to interference plus noise ratio (signal to interference plus noise ratio, SINR), or may include another parameter representing the quality of the beam, such as a ratio of an RSRP of the beam to a related threshold.

In the examples described above, abeam priority of a first beam in the inference beam set satisfies one or more of the following conditions: the beam priority of the first beam is positively correlated with importance of the first beam; the beam priority of the first beam is positively correlated with quality of the first beam; or the beam priority of the first beam is negatively correlated with an amount of resources for monitoring the first beam.

In an implementation, a priority Pᵢ of an i^{th} beam in the inference beam set may be: Pᵢ=Uᵢ*Qᵢ/Dᵢ, where Uᵢ denotes importance of the beam; Qᵢ denotes a quality indicator of the beam; and Dᵢ denotes an amount of resources required for monitoring the i^{th} beam.

In an example, the first beam set may be determined based on historical performance data of some or all of beams in the inference beam set. For example, the historical performance data may be used to construct a statistical model of beam performance, and the first beam set may be selected based on the statistical model. Based on the statistical model, it is also possible to predict which beams may experience performance changes at future instants. Therefore, based on the statistical model constructed based on historical performance data, the system may more effectively select beams to be monitored.

In the examples described above, based on the statistical model, beams that may experience significant performance fluctuations at future instants may be preferentially selected for monitoring, thereby improving monitoring effectiveness. A commonly used statistical model may be an auto-regressive moving average model (auto-regressive moving average model, ARMA). The ARMA model may predict a future beam state based on the historical performance data.

In an implementation, the ARMA model may be represented as: γₜ=α₁γₜ₋₁+α₂γₜ₋₂+ . . . +β₁eₜ₋₁+β₂eₜ₋₂+ . . . , where γₜ denotes performance (such as RSRP or SINR) of a current beam; eₜ denotes an error term, representing a difference between an observed value and a predicted value; and both α_{*} and β_{*} are model parameters obtained by fitting historical data.

In an example, the first beam set may be determined based on user quality of experience (quality of experience, QoE) corresponding to some or all of beams in the inference beam set. That is, the first device may select, based on user perception, a monitoring data set for performance monitoring.

In the examples described above, the first device may preferentially monitor beams or resources that significantly affect user experience. For example, when a user in a specific area reports degraded signal quality or application lag, the system may immediately select a related beam for monitoring. This method can directly optimize user experience. It may be learned that the system may preferentially select a beam with degraded user experience for performance monitoring.

In an example, the first beam set may be determined based on a coverage area of some or all of beams in the inference beam set. A quantity of users in the coverage area of the beams and/or a user level may be used for determining beam priorities, or may be directly used for determining the first beam set.

In an example, the first beam set may be determined based on a network load of a cell in which the first device is located. The first beam set may be dynamically configured based on a current load. When the network load changes in the first monitoring instance, the first beam set may be adjusted in a timely manner.

In an example, the first beam set may alternatively be determined based on one or more of the beam priority, the historical performance data, the quality of experience, the coverage area, or the network load of the cell in the first information described above.

In some embodiments, a beam subset for transmitting a reference signal for a respective monitoring instance may be dynamically adjusted based on a current network state and beam prediction requirement, so as to ensure that collected data is sufficiently timely and representative.

In some embodiments, the first beam subset determined based on the first information may be one of a plurality of beam subsets in the inference beam set. A plurality of beam subsets may be determined from the inference beam set based on the first information. The plurality of beam subsets may be separately configured with different monitoring levels. During performance monitoring, beam subsets with different monitoring levels are selected according to monitoring requirements.

In an example, which beams or resources should be preferentially monitored is determined based on historical data of the network, a user requirement, or a service type. The beam priority is used as an example. Abeam having a high priority may provide signal coverage for a key area (for example, a high-density user area or a VIP user location), and a beam having a low priority may be located in an area with a relatively small load or a stable load and is therefore assigned a low monitoring level.

In some embodiments, to fully cover all of beams in the inference beam set, the first beam set may be determined based on a polling mechanism related to the inference beam set. The polling mechanism may classify, in a polling manner, all of beams in the inference beam set into a plurality of beam subsets corresponding to a plurality of monitoring instances. It may be learned that, to prevent the first device from measuring the whole inference beam set (possibly including a large quantity of beams) in each monitoring period, the inference beam set may be divided into a plurality of subsets, and all of beams are gradually covered in a plurality of monitoring periods in a polling manner.

In an example, the inference beam set is divided into several non-overlapping subsets S₁, S₂, . . . , Sₙ, where each subset Sᵢ includes some of beam resources. For example, if the inference beam set includes 128 beams, the inference beam set may be divided into four subsets, with each subset including 32 beams.

In the embodiments described above, the plurality of beam subsets may correspond to a same reference signal, or may correspond to different reference signals. The inference beam set may be cyclically traversed for monitoring based on the polling mechanism by using the reference signals corresponding to the plurality of beam subsets.

In some embodiments, after division of the inference beam set, a polling period may be defined, and all beam subsets may be sequentially measured in the period. Each beam subset may correspond to one monitoring instance, for example, the first monitoring instance. A plurality of monitoring instances including the first monitoring instance constitute a polling period, that is, a first polling period. It may be learned that the polling mechanism may be used for performance monitoring for all of beams in the inference beam set in the first polling period. That is, when the first beam set includes only part of beams in the inference beam set, all of beams in the inference beam set may be monitored based on the polling mechanism and the plurality of monitoring instances.

In the embodiments described above, in different performance monitoring instances, different parts of the inference beam set are selected to be monitored, to ensure that the whole inference beam set may be gradually covered in a plurality of monitoring periods. This method can reduce measurement complexity for each monitoring instance, and ensure data integrity through continuous monitoring.

In the embodiments described above, based on the polling mechanism, different beam subsets in the inference beam set may be covered in a specific time interval for performance monitoring of the first model. The time interval may be referred to as duration of one polling period.

In an example, the first beam set is a first beam subset of the inference beam set, and the first beam subset is determined based on the polling mechanism of the inference beam set. The first beam subset may be one in a set of non-overlapping beam subsets defined for the inference beam set. A plurality of non-overlapping beam subsets are used for implementing polling-based monitoring of the inference beam set at a plurality of time instances.

In an example, the first polling period includes a plurality of monitoring instances, the plurality of monitoring instances include the first monitoring instance, the plurality of monitoring instances respectively correspond to a plurality of beam subsets including the first beam subset, and any two beam subsets in the plurality of beam subsets include different beams.

In an implementation, it is assumed that a plurality of beams in the inference beam set may be divided into n beam subsets based on the polling mechanism. A beam subset selected for each monitoring instance may be Sᵢ={B_{i,1}, B_{i,2}, . . . , B_{i,ki}}, i=1, 2, . . . , n, where Sᵢ denotes an i^{th} beam subset, ki denotes a quantity of beams in the i^{th} beam subset, and B_{i,j} denotes j^{th} beam in the i^{th} beam subset.

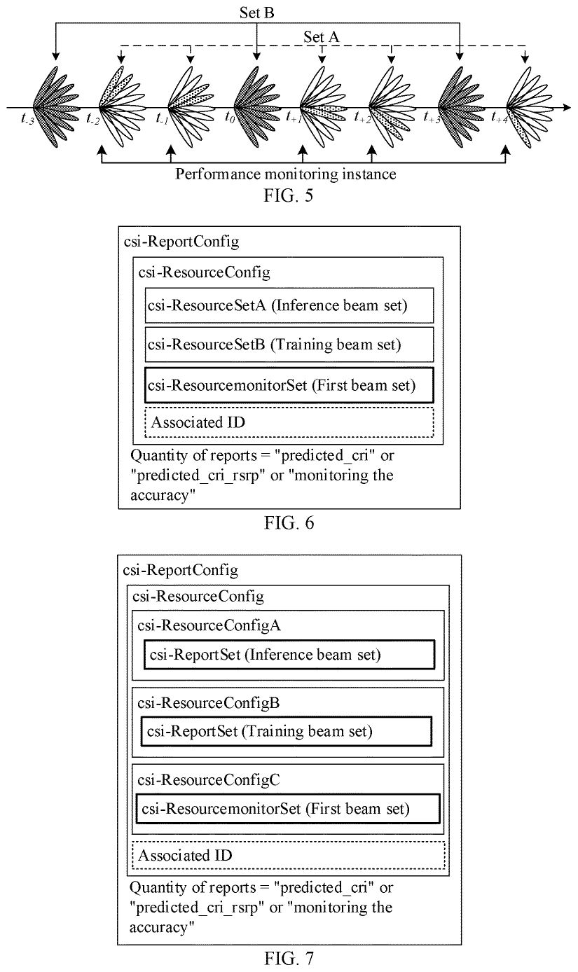

For ease of understanding, a method for determining the first beam set based on the polling mechanism is described below by using an example with reference to FIG. 5. Same as in FIG. 4, the set B in FIG. 5 is the training beam set of the first model, and the set A is the inference beam set of the first model. Similarly, on a time axis, the training beam set of the first model is transmitted at each of time instances [t₋₃, t₀, t₊₃], the inference beam set of the first model is transmitted at each of time instances [t₋₂, t₋₁, t₊₁, t₊₂, t₊₄], and the time instances [t₋₂, t₋₁, t₊₁, t₊₂, t₊₄] correspond to a plurality of performance monitoring instances.

FIG. 5 differs from FIG. 4 in that, at each time instance corresponding to the inference beam set, beam subsets for performance monitoring are only part of beams filled with shaded areas. That is, the inference beam set is greater than a beam set corresponding to a performance monitoring instance.

Still referring to FIG. 4, time instances [t₋₂, t₋₁, t₊₁, t₊₂, t₊₄] may be used as one polling period to cover nine beams in the inference beam set. Each of beam subsets corresponding to time instances [t₋₂, t₋₁, t₊₁, t₊₂] includes two beams, and a beam subset corresponding to the time instance t₊₄ includes the remaining one beam.

In some embodiments, the first polling period may be greater than or equal to the first monitoring period. For example, when the first monitoring period includes one monitoring instance, the first polling period is greater than the first monitoring period. For another example, when the first monitoring period includes a plurality of monitoring instances, the first polling period may be equal to the first monitoring period.

In an example, duration of the first polling period is a positive integer multiple of duration of the first monitoring period. The first monitoring period may include at least one monitoring instance. Optionally, the positive integer multiple may be determined based on RS resource configuration and duration of a CSI reporting period.

In an example, a quantity of monitoring periods included in the first polling period is a quantity of beam subsets obtained by dividing the inference beam set. For example, in the example shown in FIG. 4, a beam subset S₁ is measured in the 1^{st} monitoring period, a beam subset S₂ is measured in the 2^{nd} monitoring period, and so on, and after all of beam subsets in the inference beam set are covered, a new round of polling is restarted.

In some embodiments, a value of the first polling period may be dynamically adjusted. When the first polling period is determined based on one or more pieces of information, the value of the first polling period may be adjusted depending on changes in the information. One or more pieces of information for determining the first polling period may include a moving speed of the first device; a network load of a cell in which the first device is located; and a maximum polling period of a cell in which the first device is located.

In an example, the first polling period is linearly correlated with the moving speed of the first device. When the moving speed of the first device increases, duration of the first polling period may be reduced, to ensure that a channel state can be updated in a timely manner.

In an example, the first polling period is linearly correlated with the network load of the cell in which the first device is located. When the network load of the cell in which the first device is located increases, duration of the first polling period may be reduced, to adapt to a requirement for more frequent data reporting.

In an example, the first polling period is related to the maximum polling period of the cell in which the first device is located. The first polling period is less than or equal to the maximum polling period. For example, the first polling period may be set to 80% of the maximum polling period.

In an example, the first polling period is alternatively related to a monitoring period of the first model or a reporting period of monitoring reports. Duration of the first polling period is an integer multiple of duration of the first monitoring period, or duration of the first polling period is an integer multiple of duration of the reporting period.

In an example, the first polling period may be dynamically adjusted based on the moving speed of the first device, the network load, and the maximum polling period. For example, the value of the first polling period is a value obtained by subtracting duration corresponding to the moving speed and duration corresponding to the network load from the maximum polling period.

In an implementation, the first polling period T may be: T=Tₘₐₓ−α*ν−β*L, where α and β are weight coefficients, Tₘₐₓ denotes the maximum polling period, ν denotes an impact of the moving speed on the first polling period, and L denotes an impact of the network load on the first polling period.

Optionally, T and Tₘₐₓ represent the duration of the polling period, which is in the unit of seconds. Tₘₐₓ may be pre-configured by the network. For example, the network may determine the value based on a size of the cell and whether the cell is a cell that covers a high-mobility terminal device.

Optionally, the two weight coefficients may be used for balancing the impact of the moving speed of the first device and the impact of the network load on the first polling period.

Optionally, ν may represent duration that affects the first polling period and that is obtained by converting the moving speed of the first device.

Optionally, L may represent duration that affects the first polling period and that is obtained by converting a current load of the cell, and the duration may be derived from a congestion rate of a current network.

In some embodiments, in the polling mechanism, a quantity of beams in each of the beam subsets that include the first beam subset may also be dynamically adjusted. In an example, a jointly optimized model may be obtained by dynamically adjusting both the first polling period T and a beam subset size S, thereby maximizing network performance while satisfying requirements in different scenarios.

In an implementation, assuming that all of beams in the inference beam set are gradually covered in a plurality of periods, a total delay T_{delay} for covering all of the beams may be expressed as:

$${T}_{delay} = \frac{N}{s} \times {T}_{monitor} ,$$

where N denotes a total quantity of beams in the inference beam set, S denotes a subset size obtained after dynamic adjustment, and Tₘₒₙᵢₜₒᵣ denotes a monitoring period.

In the implementation described above, the network (network, NW) may dynamically adjust S and T, such that T_{delay} is minimized while satisfying monitoring accuracy requirements, thereby achieving performance optimization.

Two manners of determining the first beam subset are respectively described above with reference to FIG. 4 and FIG. 5. Regardless of whether the first beam subset is determined based on the polling mechanism, the quantity of beams in the first beam subset can be dynamically adjusted to meet actual requirements. To improve monitoring accuracy of the first model, during dynamic adjustment, the quantity of beams in the first beam subset may be related to one or more of the following information: prediction accuracy of the first model; a network load of a cell in which the first device is located; or a minimum quantity of beams in the first beam subset.

In an example, the quantity of beams in the first beam subset is linearly correlated with the prediction accuracy of the first model. When a high prediction accuracy is required, the quantity of beams may be increased, to obtain more beam data, thereby improving the prediction accuracy.

In an example, the quantity of beams in the first beam subset is linearly correlated with the network load of the cell in which the first device is located. When the network load increases, the quantity of beams may be reduced, so as to reduce a measurement data amount and reduce network pressure.

In an example, the quantity of beams in the first beam subset is related to the minimum quantity of beams in the first beam subset. The minimum quantity of beams may be configured by the network. The quantity of beams in the first beam subset is greater than or equal to the minimum quantity of beams.

In an example, the quantity of beams in the first beam subset may be dynamically adjusted based on the prediction accuracy of the first model, the network load of the cell, and the minimum quantity of beams. For example, the quantity of beams in the first beam subset may be a value obtained by subtracting a parameter corresponding to the network load from a sum of the minimum quantity of beams and a parameter corresponding to the prediction accuracy.

In an implementation, in a case that the first beam subset is an i^{th} beam subset in a plurality of beam subsets, i is an integer greater than or equal to 1, and the quantity Sᵢ of beams in the first beam subset may be: Sᵢ=Sₘᵢₙ+γ*E−δ*L, where γ and δ are weight coefficients, Sₘᵢₙ denotes the minimum quantity of beams, E denotes an impact of the prediction accuracy on the quantity of beams, and L denotes an impact of the network load on the quantity of beams.

Optionally, E may denote a related parameter obtained by converting a requirement for prediction accuracy. The requirement is, for example, that a target threshold for prediction accuracy ranges from 0 to 1.

Optionally, L may denote a related parameter that affects the quantity of beams and that is obtained by converting a current load of the cell, and the related parameter may be derived from a congestion rate of a current network.

Optionally, Sᵢ may also denote a beam subset size for each CSI reporting period, namely, a quantity of beams to be measured in each reporting period.

In some embodiments, the first reference signal may be directly transmitted by the second device, or may be transmitted by the second device in response to a request. In an example, the first device may transmit a first request to the second device, to request for the first reference signal for performance monitoring.

In some embodiments, a dedicated resource set for the first beam set or the first reference signal is determined based on a dedicated CSI report configuration. When a dedicated resource set for monitoring and a report configuration for monitoring are configured in a dedicated CSI report configuration for monitoring, a connection between resource sets RS is required to be identified for monitoring. The first device may also measure, based on this connection, a beam to be monitored, and report a measurement result.

In an example, the dedicated resource set for performance monitoring is an RS resource set configured by the network, and may also be referred to as a monitoring RS resource set.

In an example, a current beam measurement and reporting framework allows a configuration of an RS resource set for the first device. The report configuration may further include a CSI-RS resource set corresponding to the first beam set (the inference beam set or a part of the inference beam set).

In an example, the first beam set may be associated with a same identity (identity, ID) as the inference beam set or the training beam set of the first model, so as to facilitate measurement by the first device. In a case that an associated ID (associated ID) of the inference beam set is the same as that of the training beam set, the first beam set is associated with a same ID as both the inference beam set and the training beam set. That is, a first associated identity corresponding to the first beam set is the same as the associated identity of the inference beam set and/or the associated identity of the training beam set of the first model. For example, a same associated ID is configured for the set A, the set B, and a monitoring set. Example descriptions are provided below with reference to FIG. 6 to FIG. 8.

In an implementation, in a CSI framework, the associated ID may be transmitted and tagged together with a CSI reference signal (CSI-RS), such that an AI/ML model can determine beam selection by using the same associated ID in the measurement phase, the inference phase, and the monitoring phase. For example, the associated ID may be indicated by using a CSI-RS resource index. Each CSI-RS resource has its unique ID, and the AI/ML model may identify, by using the index, CSI-RS measured values associated with different beam directions.

In an example, an associated ID is configured for each of the inference beam set and the training beam set, and no associated ID is configured for the first beam set.

In some embodiments, when the inference beam set is monitored in a polling manner (namely, the polling mechanism), the polling period is required to be considered in resource configuration and report configuration of the first beam set, to cover all of beams in the inference beam set.

In an example, in a case that the first beam set is one of a plurality of beam subsets of the inference beam set determined based on the polling mechanism, during configuration of CSI reports and configuration of RS resources through the CSI report configuration, it is required to ensure effective coverage of all of beams in the inference beam set while maintaining resource efficiency for monitoring. For example, all configurations in one polling period may be completed using a plurality of csi-ReportConfig. For another example, during configuration of RS resources, it is required to ensure that resource allocation for each beam subset is appropriate for the polling mechanism, so as to support effective measurement.

In an example, a plurality of beam subsets including the first beam set are in a one-to-one correspondence with a plurality of resource configurations in the first polling period. Each resource configuration may be used for configuring one RS resource set. It may be learned that the plurality of beam subsets may be in a one-to-one correspondence with the plurality of RS resource sets. For example, a separate RS resource set is configured for each beam subset Si to ensure that the first device can measure a beam in the beam subset in one polling period. The following provides an exemplary description with reference to FIG. 9.

In an implementation, a separate CSI-RS resource or a demodulation reference signal (demodulation reference signal, DMRS) of a physical downlink control channel (physical downlink control channel, PDCCH) may be configured for each beam subset Si in the inference beam set, for performing performance monitoring in one polling period. From each beam subset, a key beam may also be selected as a measurement target of RS resources, so as to ensure that reported Top-K beam information can sufficiently reflect overall performance of the beam subset. Optionally, a beam with relatively good performance in history or a beam with relatively high signal strength in a current environment may be preferentially selected for measurement.

In some embodiments, the network may dynamically adjust configuration of RS resources according to real-time requirements, to improve flexibility of RS resource configuration. For example, in a high-mobility scenario, the network may reduce the polling period and increase the RS resource density to improve timeliness and accuracy of measurement.

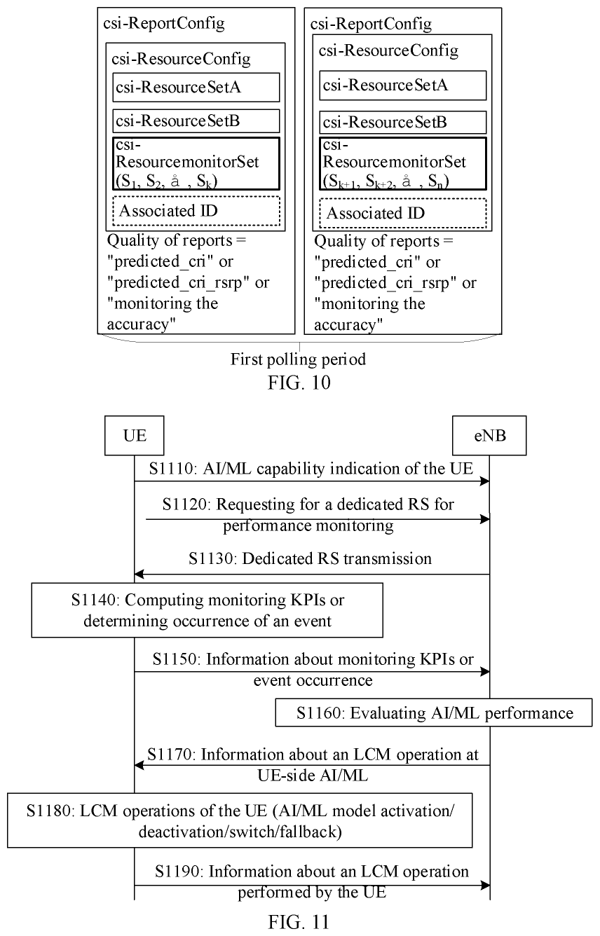

In an example, a plurality of beam subsets including the first beam set correspond to M resource configurations, where M denotes a quantity of reporting periods in the first polling period. For example, in a case that the first polling period includes two reporting periods, resources for a plurality of beam subsets may be configured simultaneously by using one resource configuration. That is, resources are configured for the plurality of beam subsets at one time. The following provides an exemplary description with reference to FIG. 10.

In some embodiments, the AI/ML model may predict a future location based on a historical moving trajectory of a user, thereby dynamically adjusting the CSI reporting period and subset size. For example, when it is predicted that a user enters a high-mobility area, RS resources are configured with high density, and a plurality of monitoring subsets are configured in one resource configuration, so that the polling period may be reduced in advance.

In some embodiments, the AI/ML model may dynamically adjust subsequent polling configurations based on a CSI report result fed back in real time and an AI/ML algorithm. For example, if significant fluctuations are found in beam signal strength of a current subset, the subset may be expanded in a next period to ensure that more beams are covered. By dynamically adjusting duration of the polling period, the CSI report trigger mechanism, and the subset size, the network may flexibly optimize the CSI report configuration under different network conditions and user requirements, to implement efficient and accurate performance monitoring. This dynamic adjustment policy can ensure that all of beams in the inference beam set are sufficiently covered, and resource utilization is optimized, to meet performance requirements in different scenarios.

Still referring to FIG. 3, in Step S320, the first device performs performance monitoring on the first model based on a measurement result of the first beam set.

The measurement result of the first beam set may include a direct measurement parameter of the first beam set, and may further include a performance parameter of the first model that is determined based on the measurement parameter. The direct measurement parameter is, for example, RSRP. The performance parameter is as described above, and is not described again.

In some embodiments, the performance parameter of the first model may be determined by comparing a predicted result with an actual measurement result. These results may be Top-1 beam or Top-K beams in the inference beam set, or may be a parameter such as an RSRP difference. For example, in a case that the first beam set is the inference beam set or the plurality of beam subsets including the first beam set cover the inference beam set, whether the first model has any problems may be determined by comparing predicted Top-K beams with Top-K beams determined by measurement. In other words, after RSs for performance monitoring cover the entire inference beam set, an inference error may be measured by comparing a Top-1 beam/Top-K beams predicted by the model with an actual top beam determined by measurement. For another example, prediction accuracy of the Top-1 beam or Top-K beams may be obtained by comparing the predicted result with a measured value of a resource set/resource that is obtained by performance monitoring.

In an example, whether the first model is accurate is determined based on information about an L1-RSRP difference between an actual L1-RSRP measured value of one or more predicted top beams and an L1-RSRP measured value of a resource set/resource for monitoring.

In an example, prediction accuracy of the Top-1 beam with margin may be evaluated by measuring a difference in RSRP between a predicted beam and a top beam. In a case that the RSRP difference is less than a set threshold, it is considered that the prediction succeeds, and the first model is accurate.

In an example, in a case that a maximum L1-RSRP measured value of the Top-K predicted beams is in a margin of a maximum L1-RSRP measured value of beams in the first beam set, the best beam in the Top-K predicted beams is selected for use. This scenario may occur after the first device measures the Top-K predicted beams and finds the best beam having the maximum L1-RSRP. Compared with the L1-RSRP of the top beam in the first beam set, as long as the L1-RSRP of the top beam in the Top-K predicted beams is in a set margin or a computed margin, any performance degradation caused by using the predicted Top-K beams or the top beam is considered tolerable compared to an actual best beam, which is interpreted as a successful event.

In an example, the performance parameter of the first model may be represented by a monitoring margin of the first model. For example, the monitoring margin of the first model may be determined based on an actual quantity of monitoring times of the performance monitoring and a difference in quality between a beam in the inference beam set and a corresponding beam in the first beam set.

In an implementation, the monitoring margin may be:

$$Margin = \frac{1}{N} {Σ}_{i = 1}^{N} 1 ( \vert RSRP ( {b}_{i} ) - RSRP ( {b}_{i}^{*} ) \vert \leq ε ) ,$$

where N denotes the actual quantity of monitoring times, ε denotes a margin threshold, RSRP(bᵢ) denotes predicted RSRP of a beam b in the inference beam set during an i^{th} monitoring operation, and RSRP(bᵢ^{*)} denotes measured RSRP of a beam b in the first beam set during the i^{th} monitoring operation.

Optionally, ε denotes a preset margin threshold, and may be used for determining whether a difference in RSRP between the predicted beam and an actual beam is acceptable.

Optionally, 1 (⋅) is an indication function. When a difference between the predicted result and the actual measurement result is in a preset margin range, 1 is returned; otherwise, 0 is returned. A same margin value may be used for a plurality of predicted top beams, or different margin values may be configured for a plurality of predicted top beams.

Optionally, the beam b may be a predicted top beam or a plurality of preferred beams in the first beam set.

In some embodiments, the first beam set includes the predicted Top-K beams in the inference beam set. Assuming that a total quantity of monitoring instances is N_{instance}, and a quantity of monitoring instances actually used for monitoring is Nₘₒₙᵢₜₒᵣ, performance monitoring accuracy related to prediction of the Top-K beams is Nₘₒₙᵢₜₒᵣ/N_{instance}.

In some embodiments, after performance monitoring is performed, the first device may further transmit a monitoring report of the first model to the second device. For example, for network device side performance monitoring used for beam prediction at the first device, the network may be required to configure/indicate an RS resource set as monitoring RS resources, and the first device may measure these monitoring RS resources and transmit a monitoring report to the network.

In some embodiments, the monitoring report may include a performance parameter of the first model. As described above, the performance parameter of the first model includes prediction accuracy of the first model and/or a prediction error of the first model. For example, performance indicators or related KPIs (such as beam prediction accuracy and RSRP difference) may be computed based on report measured values corresponding to the monitoring RS resources and an inference-related report. The computed performance indicators or related KPIs may be used for evaluating operability of CSI reporting related to beam prediction.

In an example, the CSI reporting framework may be used for configuring a monitoring RS resource set, and obtaining a beam measurement report corresponding to the monitoring RS resource set. The beam measurement report may include a CSI-RS resource indicator (CSI-RS resource indicator, CRI) for measuring an RS resource, or a parameter such as RSRP or SINR.

In an example, the network may obtain a beam measurement/report of monitoring an RS resource set in the CSI reporting framework by using different CSI reports (monitoring reports). The report may include L1-RSRP and RS indexes of Top-K beams in a monitoring RS group.

In some embodiments, the first device may transmit monitoring reports based on different CSI reporting mechanisms, to support network side performance monitoring. In an example, the network may use different time behavior configurations and CSI reporting frameworks related to the monitoring reports. These time behavior configurations may be aperiodic (aperiodic, AP), periodic (periodic, P), or semi-persistent (semi persistent, SP). Accordingly, the first device may configure and transmit a periodic beam report, an aperiodic beam report, and a semi-persistent beam report.

In an example, based on the related L1-CSI reporting frameworks, monitoring reports may be transmitted by using a periodic reporting mechanism, an aperiodic reporting mechanism, or a semi-persistent signal reporting mechanism to achieve reporting of accuracy or Top-K beam measurements in model monitoring.

In some embodiments, the monitoring report of the first model is configured through a first CSI report configuration. In an example, the first CSI report configuration may be the same as a CSI report configuration corresponding to the inference beam set. In an example, the first CSI report configuration may be different from the CSI report configuration corresponding to the inference beam set.

In an example, in a case that the first beam set is the inference beam set, the first CSI report configuration is the same as the CSI report configuration corresponding to the inference beam set. That is, the monitoring RS resource set is equal to a resource set of the inference beam set. In this scenario, a same RS resource set is used for model inference and model monitoring.

In an example, in a case that the first beam set is a beam subset of the inference beam set, the first CSI report configuration is the same as the CSI report configuration corresponding to the inference beam set. That is, the first beam set includes only part of beams in the inference beam set. In this scenario, a same CSI report configuration is used for model monitoring and model inference.

In an example, in a case that the first beam set is the inference beam set, the first CSI report configuration is different from the CSI report configuration corresponding to the inference beam set. That is, the monitoring RS resource set and the resource set of the inference beam set are configured/indicated separately.

In an example, in a case that the first beam set is a beam subset of the inference beam set, the first CSI report configuration is different from the CSI report configuration corresponding to the inference beam set.

In an example, regardless of whether the first beam set is a subset of the inference beam set or equal to the inference beam set, the first CSI report configuration and the CSI report configuration of the inference beam set may be configured separately, or configured by using a same CSI report configuration.

In an example, configuration and indication of the monitoring RS resource set in different scenarios may further be considered in the first CSI report configuration. The monitoring RS resource set corresponds to the first beam set. The first beam set may be configured explicitly or implicitly. For example, in a case that the first beam set is a subset of the inference beam set, the network may configure/indicate that a CSI-RS resource set corresponding to the beam subset of the inference beam set is the monitoring RS resource set, and further configure a timeline and a reporting amount for the monitoring RS resource set.

In some embodiments, the first device may transmit the monitoring report of the first model based on a reporting period of performance monitoring. The reporting period of performance monitoring may be determined based on different CSI reporting mechanisms.

In an example, the reporting period may be the same as the monitoring period. In a polling period, only one beam subset may be measured in each reporting period, which can significantly reduce a measurement burden of the first device and save resources. After a plurality of reporting periods, the first device may gradually cover all of beams in the inference beam set in a polling manner, so as to ensure that all of the beams are measured. As described above, the network may dynamically adjust the duration of the polling period and the subset size according to network conditions, to ensure effectiveness of performance monitoring in different scenarios.

In some embodiments, in a scenario where performance monitoring is performed based on the polling mechanism, a beam subset corresponding to the polling mechanism may be configured in a first configuration of the monitoring report, and phased monitoring reports may be supported. Optionally, the first configuration may include one or more of a trigger type of the monitoring report, a beam subset indication, or monitoring report content.

In an example, in a case that the first configuration is a CSI report configuration based on a CSI framework, the first configuration may include a trigger type of a CSI report, a beam subset indication, or CSI report content. Content of the three are specifically as follows.

For the trigger type of the CSI report, a periodic, aperiodic, or semi-persistent CSI report trigger mechanism may be used to ensure that the first device can periodically report monitoring data. CSI reports for corresponding beam subsets are activated in different polling periods.

For the beam subset indication, the network may configure a plurality of CSI reports in each polling period to specify beam subsets that are currently required to be measured. For example, the network may configure a beam subset S₁ as a measurement target of a CSI report in the 1^{st} monitoring period in each polling period, and then configure a subset S₂ as a measurement target in a next monitoring period, as shown in FIG. 9.

For the CSI report content, the content may include L1-RSRP values and RS indexes of Top-K beams in a beam subset. In this way, the network may acquire a beam offering the best performance in each beam subset, and accordingly compute prediction accuracy of the model based on the information.

The method for determining the first beam set for performance monitoring is described above with reference to FIG. 3 to FIG. 5. It may be learned from the foregoing description that the first beam set may be configured with a same associated ID as the training beam set and the inference beam set. The following describes, with reference to FIG. 6 to FIG. 8 using a configuration manner of the CSI framework as an example, an example of a method for configuring an associated ID of the first beam set.

The beam sets and the associated IDs in FIG. 6 to FIG. 8 are configured using a CSI report configuration (csi-ReportConfig). Throughout the AI/ML-based beam management process, associated IDs may be configured based on CSI-RS resource indexes during model training, model inference, and model detection (monitoring). For example, in the CSI framework, the inference beam set and the training beam set are configured as different CSI resource sets in csi-ResourceConfig, but each of them has an associated ID. The resource set of the inference beam set is configured using csi-ResourceSetA, the resource set of the training beam set is configured using csi-ResourceSetB, and the resource set of the monitoring set (the first beam set) is configured using csi-ResourcemonitorSet. The following describes three different configuration manners with reference to the accompanying drawings.

Referring to FIG. 6, in csi-ReportConfig, the inference beam set, the training beam set, and the first beam set corresponding to different CSI resource sets are configured in a same CSI resource configuration (csi-ResourceConfig). The three beam sets share a same associated ID, and the associated ID is also in the CSI resource configuration.

Compared to FIG. 6, although the inference beam set, the training beam set, the first beam set, and the associated ID in FIG. 7 are all in a same CSI resource configuration, the inference beam set, the training beam set, and the first beam set respectively correspond to different CSI resource configuration indexes (csi-ResourceConfigId). That is, the inference beam set, the training beam set, and the first beam set are configured separately based on different CSI resource configuration indexes.

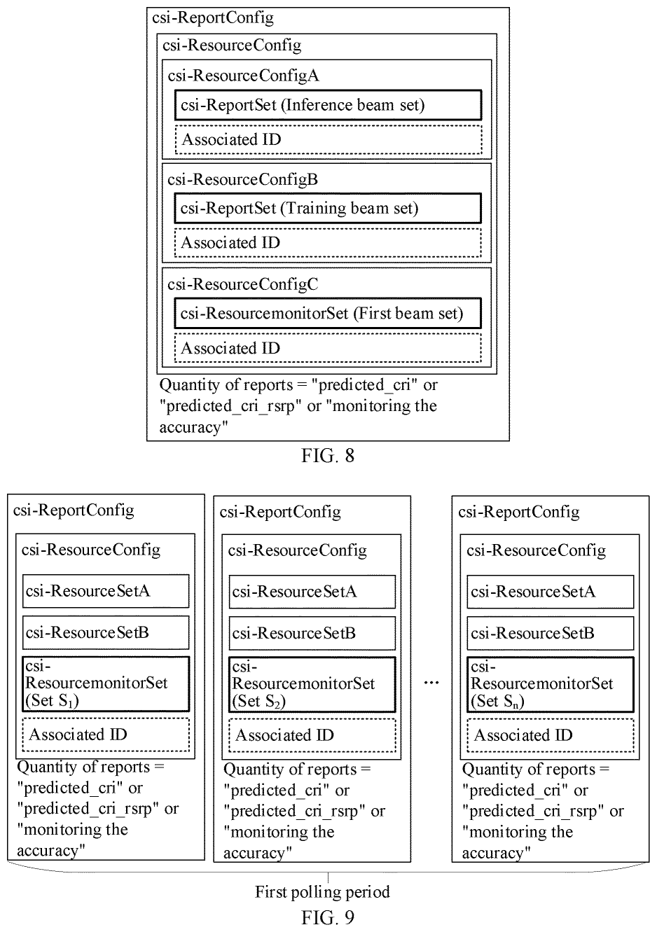

Compared to FIG. 7, the inference beam set, the training beam set, and the first beam set in FIG. 8 are also configured separately, but associated IDs corresponding to different beam sets are configured in different CSI resource configuration indexes. In the method illustrated in FIG. 8, since the associated IDs are configured separately in different csi-ReportConfigId, a scenario with different associated IDs may be met. In addition, no additional csi-ResourceConfig is required even if there are different associated IDs, which is more conducive to reducing report configuration overheads.

In FIG. 7 and FIG. 8, each csi-ReportConfigId is constructed in a single csi-ReportConfig. It should be noted that different csi-ReportConfigId may be separately configured in different csi-ReportConfig.

It may be learned from the foregoing description that, when performance monitoring is performed on a plurality of beam subsets generated based on the polling mechanism, RS resource sets may be in a one-to-one correspondence with the plurality of beam subsets, or may be flexibly configured according to an actual situations. The following describes two configuration manners with reference to FIG. 9 and FIG. 10 by using the CSI framework in FIG. 6 as an example.

Referring to FIG. 9, in the first polling period, the inference beam set is divided into n beam subsets, which are sets S₁, S₂, . . . , Sₙ, respectively. A CSI resource configuration for the first polling period includes n csi-ReportConfig. The n csi-ReportConfig are in a one-to-one correspondence with the n beam subsets.

Compared to FIG. 9, the inference beam set in FIG. 10 is also divided into n beam subsets, but the first polling period is determined based on two reporting periods. In this scenario, resources are required to be configured for a plurality of monitoring subsets by using two csi-ReportConfig. Referring to FIG. 10, the two csi-ReportConfig respectively correspond to beam subsets {S₁, . . . , Sₖ} and {Sₖ₊₁, Sₖ₊₂, . . . , Sₙ}.

Optionally, a corresponding RS may be configured for each of the two beam subsets {S₁, . . . , Sₖ} and {Sₖ₊₁, Sₖ₊₂, . . . , Sₙ} by using the two csi-ReportConfig in FIG. 10, to improve performance monitoring accuracy.

The method for determining the first beam set for performance monitoring and the related configurations are described above with reference to FIG. 3 to FIG. 10. The first beam set is used for transmitting a dedicated RS for performance monitoring. The related configurations include configurations of an RS resource and a monitoring report. To describe the application of embodiments of the present application more clearly, the following describes, with reference to FIG. 11 by using an example in which the first device is a UE and the second device is a base station (eNB), an example in which the first device requests a dedicated reference signal from the second device and transmits a monitoring report.

In Step S1110, the UE transmits capability indication information of the UE to the base station. For example, the UE transmits an AI/ML capability indication of the UE (UE AI/ML capacity indication) to the base station.

In Step S1120, the UE transmits a request (a first request) to the base station to request for a dedicated RS for performance monitoring (request for dedicated RS for performance monitoring), to perform performance detection on the model.

In Step S1130, the base station transmits the dedicated RS (dedicated RS for transmission) based on the request from the UE, to support performance detection.

In Step S1140, the UE computes monitoring KPIs or determines an event trigger condition (compute monitoring KPIs or determine occurrence of event) based on the received dedicated RS.

In Step S1150, the UE transmits information about a KPI detection result or a trigger event (information about monitoring KPIs or event occurrence) to the base station based on a performance detection and evaluation result.

In Step S1160, the base station receives the information about the KPI detection result from the UE to evaluate performance of the model (evaluate AI/MVL performance). Optionally, the base station may perform performance evaluation and auxiliary monitoring on a model on the UE side, or may perform performance evaluation on a model on the base station side.

Correspondingly, during model monitoring, the UE may perform performance evaluation on the model on the UE side, or may perform auxiliary monitoring on the model on the base station side.

In Step S1170, the base station notifies, based on a result of the evaluation, information about LCM (life cycle management, LCM) operations for the UE-side AI/MVL (information about LCM operation for LCM at UE-side AI/ML). The related information involves aspects such as a state, configuration, monitoring, and update of the model. The information ensures best performance and consistency of the model during usage by the UE.

In Step S1180, the UE implements, based on the LCM information from the base station, LCM operations (LCM operation at UE) including activation, deactivation, switch, fallback, or update of the AI/ML model (AI/ML model activation/deactivation/switch/fallback) on the UE side.

In Step S1190, the UE notifies, based on an update result, the base station of information about an LCM operation executed at the UE (information about executed LCM operation at UE), for example, a related result obtained after the LCM operation is executed.

It may be learned from FIG. 11 that, the embodiments of the present application may be applied to performance monitoring of the model by the terminal device and the network device. Transmission of the LCM information may allow the terminal device and the network device to learn a state of the related model in a timely manner, thereby improving accuracy of the model.

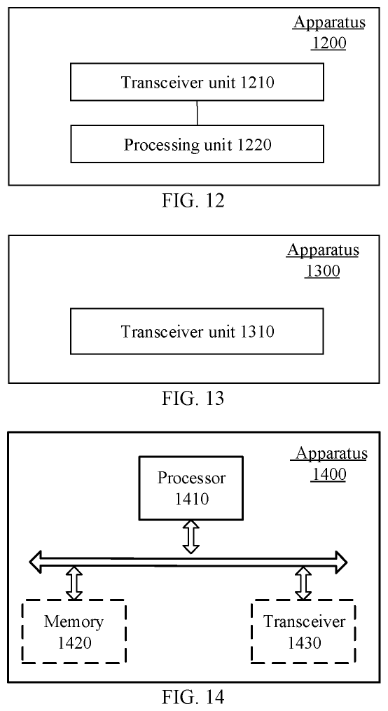

The foregoing describes the method embodiments of the present application in detail with reference to FIG. 1 to FIG. 11. The following describes in detail the apparatus embodiments of the present application with reference to FIG. 12 to FIG. 14. It should be understood that the description of the apparatus embodiments corresponds to the description of the method embodiments. Therefore, for parts that are not described in detail, one may refer to the foregoing method embodiments.

FIG. 12 is a schematic block diagram of an apparatus for wireless communication according to an embodiment of the present application. The apparatus 1200 may be any one of the first devices described above. The first device may be a terminal device. The apparatus 1200 shown in FIG. 12 includes a transceiver unit 1210 and a processing unit 1220.

The transceiver unit 1210 may be configured to receive a first reference signal, where the first reference signal is transmitted using a first beam set.

The processing unit 1220 may be configured to perform performance monitoring on a first model based on a measurement result of the first beam set, where the first reference signal corresponds to a first monitoring instance, and the first beam set is determined based on an inference beam set of the first model. The first beam set includes all of beams in the inference beam set, or the first beam set includes part of beams in the inference beam set.

Optionally, the first beam set is a first beam subset of the inference beam set, the first beam subset is determined based on first information, and the first information includes one or more of the following information: a beam priority of a beam in the inference beam set; historical performance data of a beam in the inference beam set; sensing quality of a beam in the inference beam set; a coverage area of a beam in the inference beam set; or a network load of a cell in which the first device is located.

Optionally, the first beam subset is determined based on the beam priority, and abeam priority of a first beam in the inference beam set satisfies one or more of the following conditions: the beam priority of the first beam is positively correlated with importance of the first beam; the beam priority of the first beam is positively correlated with quality of the first beam; or the beam priority of the first beam is negatively correlated with an amount of resources for monitoring the first beam.

Optionally, the performance monitoring includes a plurality of monitoring instances, the plurality of monitoring instances include the first monitoring instance and a second monitoring instance, the second monitoring instance corresponds to a second beam subset, and the first beam subset and the second beam subset include at least one beam in common.

Optionally, the first beam set is a first beam subset of the inference beam set, the first beam subset is determined based on a polling mechanism related to the inference beam set, and the polling mechanism is used for performing performance monitoring on all of beams in the inference beam set in a first polling period.

Optionally, the first polling period includes a plurality of monitoring instances, the plurality of monitoring instances include the first monitoring instance, the plurality of monitoring instances respectively correspond to a plurality of beam subsets including the first beam subset, and any two beam subsets in the plurality of beam subsets include different beams.

Optionally, duration of the first polling period is a positive integer multiple of duration of a first monitoring period, and the first monitoring period includes at least one monitoring instance.

Optionally, the first polling period is related to one or more of the following information: a moving speed of the first device; a network load of a cell in which the first device is located; or a maximum polling period of a cell in which the first device is located.

Optionally, the first polling period is: T=Tₘₐₓ−α*ν−β*L, where α and β are weight coefficients, Tₘₐₓ denotes the maximum polling period, ν denotes an impact of the moving speed on the first polling period, and L denotes an impact of the network load on the first polling period.

Optionally, a quantity of beams in the first beam subset is related to one or more of the following information: prediction accuracy of the first model; a network load of a cell in which the first device is located; or a minimum quantity of beams in the first beam subset.

Optionally, in a case that the first beam subset is an i^{th} beam subset in a plurality of beam subsets, i is an integer greater than or equal to 1, and a quantity of beams in the first beam subset is: Sᵢ=Sₘᵢₙ+γ*E−δ* L, where γ and δ are weight coefficients, Sₘᵢₙ denotes the minimum quantity of beams, E denotes an impact of the prediction accuracy on the quantity of beams, and L denotes an impact of the network load on the quantity of beams.

Optionally, the first beam set corresponds to a first associated identity, and the first associated identity is the same as an associated identity of the inference beam set and/or an associated identity of a training beam set of the first model.

Optionally, the first beam set is one of a plurality of beam subsets, determined based on a polling mechanism, in the inference beam set; and the plurality of beam subsets are in a one-to-one correspondence with a plurality of resource configurations in a first polling period, or the plurality of beam subsets correspond to M resource configurations, where M denotes a quantity of reporting periods in the first polling period.

Optionally, the transceiver unit 1210 is further configured to transmit a first request to a second device, and the first request is used to request for the first reference signal. The first reference signal is at least one of a plurality of dedicated reference signals, and the dedicated reference signal is used for performing performance monitoring on the first model.

Optionally, the transceiver unit 1210 is further configured to transmit a monitoring report of the first model based on a reporting period of the performance monitoring, where the monitoring report includes a performance parameter of the first model, and the performance parameter of the first model includes prediction accuracy of the first model and/or a prediction error of the first model.

Optionally, the monitoring report of the first model is configured by using a first CSI report configuration; and the first CSI report configuration is the same as a CSI report configuration corresponding to the inference beam set, or the first CSI report configuration is different from a CSI report configuration corresponding to the inference beam set.

Optionally, a performance parameter of the first model is represented by a monitoring margin of the first model, and the monitoring margin is determined based on an actual quantity of monitoring times of the performance monitoring and a difference in quality between a beam in the inference beam set and a corresponding beam in the first beam set.

Optionally, the monitoring margin is:

$$Margin = \frac{1}{N} {Σ}_{i = 1}^{N} 1 ( \vert RSRP ( {b}_{i} ) - RSRP ( {b}_{i}^{*} ) \vert \leq ε ) ,$$

where N denotes the actual quantity of monitoring times, ε denotes a margin threshold, RSRP(bᵢ) denotes predicted RSRP of a beam b in the inference beam set during an i^{th} monitoring operation, and RSRP

$$( {b}_{i}^{*} )$$

denotes measured RSRP of a beam b in the first beam set during the i^{th} monitoring operation.

Optionally, the first model is an artificial intelligence model or a machine learning model.

FIG. 13 is a schematic block diagram of another apparatus for wireless communication according to an embodiment of the present application. The apparatus 1300 may be any second device described above. The second device is a network device or a terminal device. The apparatus 1300 shown in FIG. 13 includes a transceiver unit 1310.

The transceiver unit 1310 may be configured to transmit a first reference signal, where the first reference signal is transmitted using a first beam set. The first reference signal corresponds to a first monitoring instance, a measurement result of the first beam set is used for performing performance monitoring on a first model, and the first beam set is determined based on an inference beam set of the first model. The first beam set includes all of beams in the inference beam set, or the first beam set includes part of beams in the inference beam set.

Optionally, the first beam set is a first beam subset of the inference beam set, the first beam subset is determined based on first information, and the first information includes one or more of the following information: a beam priority of a beam in the inference beam set; historical performance data of a beam in the inference beam set; sensing quality of a beam in the inference beam set; a coverage area of a beam in the inference beam set; or a network load of a cell corresponding to the second device.

Optionally, the first beam subset is determined based on the beam priority, and abeam priority of a first beam in the inference beam set satisfies one or more of the following conditions: the beam priority of the first beam is positively correlated with importance of the first beam; the beam priority of the first beam is positively correlated with quality of the first beam; or the beam priority of the first beam is negatively correlated with an amount of resources for monitoring the first beam.

Optionally, the performance monitoring includes a plurality of monitoring instances, the plurality of monitoring instances include the first monitoring instance and a second monitoring instance, the second monitoring instance corresponds to a second beam subset, and the first beam subset and the second beam subset include at least one beam in common.

Optionally, the first beam set is a first beam subset of the inference beam set, the first beam subset is determined based on a polling mechanism related to the inference beam set, and the polling mechanism is used for performing performance monitoring on all of beams in the inference beam set in a first polling period.

Optionally, the first polling period includes a plurality of monitoring instances, the plurality of monitoring instances include the first monitoring instance, the plurality of monitoring instances respectively correspond to a plurality of beam subsets including the first beam subset, and any two beam subsets in the plurality of beam subsets include different beams.

Optionally, duration of the first polling period is a positive integer multiple of duration of a first monitoring period, and the first monitoring period includes at least one monitoring instance.

Optionally, the first polling period is related to one or more of the following information: a moving speed of the first device that receives the first reference signal; a network load of a cell corresponding to the second device; or a maximum polling period of a cell corresponding to the second device.

Optionally, the first polling period is: T=Tₘₐₓ−α*ν−β*L, where α and β are weight coefficients, Tₘₐₓ denotes the maximum polling period, ν denotes an impact of the moving speed on the first polling period, and L denotes an impact of the network load on the first polling period.

Optionally, a quantity of beams in the first beam subset is related to one or more of the following information: prediction accuracy of the first model; a network load of a cell corresponding to the second device; or a minimum quantity of beams in the first beam subset.

Optionally, in a case that the first beam subset is an i^{th} beam subset in a plurality of beam subsets, i is an integer greater than or equal to 1, and a quantity of beams in the first beam subset is: Sᵢ=Sₘᵢₙ+γ*E−β*L, where γ and δ are weight coefficients, Sₘᵢₙ denotes the minimum quantity of beams, E denotes an impact of the prediction accuracy on the quantity of beams, and L denotes an impact of the network load on the quantity of beams.

Optionally, the first beam set corresponds to a first associated identity, and the first associated identity is the same as an associated identity of the inference beam set and/or an associated identity of a training beam set of the first model.

Optionally, the first beam set is one of a plurality of beam subsets, determined based on a polling mechanism, in the inference beam set; and the plurality of beam subsets are in a one-to-one correspondence with a plurality of resource configurations in a first polling period, or the plurality of beam subsets correspond to M resource configurations, where M denotes a quantity of reporting periods in the first polling period.

Optionally, the transceiver unit 1310 is further configured to receive a first request transmitted by a first device, and the first request is used to request for the first reference signal. The first reference signal is at least one of a plurality of dedicated reference signals, and the dedicated reference signal is used for performing performance monitoring on the first model.

Optionally, the transceiver unit 1310 is further configured to receive a monitoring report of the first model based on a reporting period of the performance monitoring, where the monitoring report includes a performance parameter of the first model, and the performance parameter of the first model includes prediction accuracy of the first model and/or a prediction error of the first model.

Optionally, the monitoring report of the first model is configured by using a first CSI report configuration; and the first CSI report configuration is the same as a CSI report configuration corresponding to the inference beam set, or the first CSI report configuration is different from a CSI report configuration corresponding to the inference beam set.

Optionally, a performance parameter of the first model is represented by a monitoring margin of the first model, and the monitoring margin is determined based on an actual quantity of monitoring times of the performance monitoring and a difference in quality between a beam in the inference beam set and a corresponding beam in the first beam set.

Optionally, the monitoring margin is:

$$Margin = \frac{1}{N} {Σ}_{i = 1}^{N} 1 ( \vert RSRP ( {b}_{i} ) - RSRP ( {b}_{i}^{*} ) \vert \leq ε ) ,$$

where N denotes the actual quantity of monitoring times, E denotes a margin threshold, RSRP(bᵢ) denotes predicted RSRP of a beam b in the inference beam set during an i^{th} monitoring operation, and RSRP

$$( {b}_{i}^{*} )$$

denotes measured RSRP of a beam b in the first beam set during the i^{th} monitoring operation.

Optionally, the first model is an artificial intelligence model or a machine learning model.

FIG. 14 is a schematic structural diagram of a communications apparatus according to an embodiment of the present application. Dashed lines in FIG. 14 indicate that a unit or module is optional. The apparatus 1400 may be configured to implement the method described in the foregoing method embodiments. The apparatus 1400 may be a chip, a terminal device, or a network device.

The apparatus 1400 may include one or more processors 1410. The processor 1410 may support the apparatus 1400 in implementing the method described in the foregoing method embodiments. The processor 1410 may be a general-purpose processor or a dedicated processor. For example, the processor may be a central processing unit (central processing unit, CPU). Alternatively, the processor may be another general-purpose processor, a digital signal processor (digital signal processor, DSP), an application specific integrated circuit (application specific integrated circuit, ASIC), a field programmable gate array (field programmable gate array, FPGA) or another programmable logic device, a discrete gate or transistor logic device, a discrete hardware component, or the like. The general-purpose processor may be a microprocessor, or the processor may be any conventional processor or the like.

The apparatus 1400 may further include one or more memories 1420. The memory 1420 stores a program, and the program may be executed by the processor 1410, so that the processor 1410 executes the method described in the foregoing method embodiments. The memory 1420 may be separate from or integrated into the processor 1410.

The apparatus 1400 may further include a transceiver 1430. The processor 1410 may communicate with another device or chip by using the transceiver 1430. For example, the processor 1410 may transmit data to and receive data from another device or chip by using the transceiver 1430.

An embodiment of the present application further provides a computer-readable storage medium for storing a program. The computer-readable storage medium may be applied to the terminal device or the network device provided in embodiments of the present application, and the program causes a computer to execute the method executed by the terminal device or the network device in various embodiments of the present application.

The computer-readable storage medium may be any available medium accessible by a computer or a data storage device such as a server or a data center that integrates one or more available media. The usable medium may be a magnetic medium (for example, a floppy disk, a hard disk, or a magnetic tape), an optical medium (for example, a digital video disc (digital video disc, DVD)), a semiconductor medium (for example, a solid state drive (solid state drive, SSD)), or the like.

An embodiment of the present application further provides a computer program product. The computer program product includes a program. The computer program product may be applied to the terminal device or the network device provided in embodiments of the present application, and the program causes a computer to execute the method executed by the terminal device or the network device in various embodiments of the present application.

All or a part of the foregoing embodiments may be implemented by using software, hardware, firmware, or any combination thereof. When the software is used to implement embodiments, all or a part of embodiments may be implemented in a form of a computer program product. The computer program product includes one or more computer instructions.

When the computer program instructions are loaded and executed on a computer, the procedures or functions according to embodiments of the present application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (such as a coaxial cable, an optical fiber, and a digital subscriber line (digital subscriber line, DSL)) manner or a wireless (such as infrared, wireless, and microwave) manner.

An embodiment of the present application further provides a computer program. The computer program may be applied to the terminal device or the network device provided in embodiments of the present application, and the computer program causes a computer to execute the method executed by the terminal device or the network device in various embodiments of the present application.

The terms “system” and “network” in the present application may be used interchangeably. In addition, the terms used in the present application are merely used to explain the specific embodiments of the present application, and are not intended to limit the present application. In the specification, claims, and accompanying drawings of the present application, the terms “first”, “second”, “third”, “fourth”, and so on are intended to distinguish between different objects but do not describe a particular sequence. In addition, the terms “include” and “have” and any variations thereof are intended to cover a non-exclusive inclusion.

In embodiments of the present application, determining B based on A does not mean determining B based on only A, but instead B may be determined based on A and/or other information.

In embodiments of the present application, “indicate” mentioned herein may be a direct indication, or may be an indirect indication, or may mean that there is an association relationship. For example, A indicates B, which may mean that A directly indicates B, for example, B may be obtained by using A; or may mean that A indirectly indicates B, for example, A indicates C, and B may be obtained by using C; or may mean that there is an association relationship between A and B.

In embodiments of the present application, the term “corresponding” may mean that there is a direct or indirect correspondence between two elements, or that there is an association between two elements, or that there is a relationship of “indicating” and “being indicated”, “configuring” and “being configured”, or the like.

In embodiments of the present application, “pre-defining” or “pre-configuring” may be implemented by pre-storing corresponding codes, tables, or other forms that may be used to indicate related information in devices (for example, including a terminal device and a network device). A specific implementation thereof is not limited in the present application. For example, being predefined may refer to being defined in a protocol.

In embodiments of the present application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In embodiments of the present application, sequence numbers of the foregoing processes do not mean execution orders. The execution orders of the processes should be determined based on functions and internal logic of the processes, and should not be construed as any limitation on the implementation processes of embodiments of the present application.

In several embodiments provided in the present application, it should be understood that, the disclosed system, apparatus, and method may be implemented in other manners. For example, the foregoing described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or another form.

The units described as separate parts may be or may not be physically separate, and parts displayed as units may be or may not be physical units, and may be at one location, or may be distributed on a plurality of network elements. A part or all of the units may be selected based on actual requirements to achieve the objectives of the solutions of embodiments.

In addition, functional units in embodiments of the present application may be integrated into one processing unit, or each of the units may exist alone physically, or two or more units may be integrated into one unit.

The foregoing descriptions are merely specific implementations of the present application, but the protection scope of the present application is not limited thereto. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A method for wireless communication, comprising:
receiving, by a first device, a first reference signal, wherein the first reference signal is transmitted by using a first beam set; and
performing, by the first device, performance monitoring on a first model based on a measurement result of the first beam set,
wherein the first reference signal corresponds to a first monitoring instance, and the first beam set is determined based on an inference beam set of the first model; and the first beam set comprises all of beams in the inference beam set, or the first beam set comprises part of beams in the inference beam set.

2. The method according to claim 1, wherein the first beam set is a first beam subset of the inference beam set, the first beam subset is determined based on first information, and the first information comprises one or more of following information:
a beam priority of a beam in the inference beam set;
historical performance data of a beam in the inference beam set;
sensing quality of a beam in the inference beam set;
a coverage area of a beam in the inference beam set; or
a network load of a cell in which the first device is located.

3. The method according to claim 2, wherein the first beam subset is determined based on the beam priority, and a beam priority of a first beam in the inference beam set satisfies one or more of following conditions:
the beam priority of the first beam is positively correlated with importance of the first beam;
the beam priority of the first beam is positively correlated with quality of the first beam; or
the beam priority of the first beam is negatively correlated with an amount of resources for monitoring the first beam.

4. The method according to claim 2, wherein the performance monitoring comprises a plurality of monitoring instances, the plurality of monitoring instances comprise the first monitoring instance and a second monitoring instance, the second monitoring instance corresponds to a second beam subset, and the first beam subset and the second beam subset comprise at least one beam in common.

5. The method according to claim 1, wherein the first beam set is a first beam subset of the inference beam set, the first beam subset is determined based on a polling mechanism related to the inference beam set, and the polling mechanism is used for performing performance monitoring on all of beams in the inference beam set in a first polling period.

6. The method according to claim 5, wherein the first polling period comprises a plurality of monitoring instances, the plurality of monitoring instances comprise the first monitoring instance, the plurality of monitoring instances respectively correspond to a plurality of beam subsets comprising the first beam subset, and any two beam subsets in the plurality of beam subsets comprise different beams.

7. The method according to claim 5, wherein duration of the first polling period is a positive integer multiple of duration of a first monitoring period, and the first monitoring period comprises at least one monitoring instance.

8. The method according to claim 5, wherein the first polling period is related to one of more of following information:
a moving speed of the first device;
a network load of a cell in which the first device is located; or
a maximum polling period of a cell in which the first device is located.

9. The method according to claim 8, wherein the first polling period is as follows:
$$T = {T}_{max} - α * v - β * L$$
wherein α and β are weight coefficients, Tₘₐₓ denotes the maximum polling period, ν denotes an impact of the moving speed on the first polling period, and L denotes an impact of the network load on the first polling period, T denotes the first polling period.

10. The method according to claim 2, wherein a quantity of beams in the first beam subset is related to one or more of following information:
prediction accuracy of the first model;
a network load of a cell in which the first device is located; or
a minimum quantity of beams in the first beam subset.

11. The method according to claim 10, wherein in a case that the first beam subset is an i^{th} beam subset in a plurality of beam subsets, i is an integer greater than or equal to 1, and a quantity of beams Sᵢ in the first beam subset is as follows:
$${S}_{i} = {S}_{min} + γ * E - δ * L$$
wherein γ and δ are weight coefficients, Sₘᵢₙ denotes the minimum quantity of beams, E denotes an impact of the prediction accuracy on the quantity of beams, and L denotes an impact of the network load on the quantity of beams.

12. The method according to claim 1, wherein the first beam set corresponds to a first associated identity, and the first associated identity is the same as at least one of an associated identity of the inference beam set or an associated identity of a training beam set of the first model.

13. The method according to claim 12, wherein the first beam set is one of a plurality of beam subsets, determined based on a polling mechanism, in the inference beam set; and the plurality of beam subsets are in a one-to-one correspondence with a plurality of resource configurations in a first polling period, or the plurality of beam subsets correspond to M resource configurations, wherein M denotes a quantity of reporting periods in the first polling period.

14. The method according to claim 1, further comprising:
transmitting, by the first device, a first request to a second device, wherein the first request is used to request for the first reference signal,
wherein the first reference signal is at least one of a plurality of dedicated reference signals, and the dedicated reference signal is used for performing performance monitoring on the first model.

15. The method according to claim 1, further comprising:
transmitting, by the first device, a monitoring report of the first model based on a reporting period of the performance monitoring,
wherein the monitoring report comprises a performance parameter of the first model, and the performance parameter of the first model comprises prediction accuracy of the first model and/or a prediction error of the first model.

16. The method according to claim 15, wherein the monitoring report of the first model is configured by using a first channel state information (CSI) report configuration; and the first CSI report configuration is the same as a CSI report configuration corresponding to the inference beam set, or the first CSI report configuration is different from a CSI report configuration corresponding to the inference beam set.

17. The method according to claim 1, wherein a performance parameter of the first model is represented by a monitoring margin of the first model, and the monitoring margin is determined based on an actual quantity of monitoring times of the performance monitoring and a difference in quality between a beam in the inference beam set and a corresponding beam in the first beam set.

18. The method according to claim 17, wherein the monitoring margin is as follows:
$$Margin = \frac{1}{N} {Σ}_{i = 1}^{N} \text{?} 1 ( \vert RSRP ( {b}_{i} ) - RSRP ( {b}_{i}^{*} ) \vert \text{?} \leq ε ) ,$$
wherein N denotes the actual quantity of monitoring times, ε denotes a margin threshold, RSRP(bᵢ) denotes predicted reference signal received power (RSRP) of a beam b in the inference beam set during an i^{th} monitoring operation, and RSRP
$$( {b}_{i}^{*} )$$
denotes measured RSRP of a beam b in the first beam set during the i^{th} monitoring operation.

19. The method according to claim 1, wherein the first model is an artificial intelligence model or a machine learning model.

20. A method for wireless communication, comprising:
transmitting, by a second device, a first reference signal, wherein the first reference signal is transmitted using a first beam set,
wherein the first reference signal corresponds to a first monitoring instance, a measurement result of the first beam set is used for performing performance monitoring on a first model, and the first beam set is determined based on an inference beam set of the first model; and the first beam set comprises all of beams in the inference beam set, or the first beam set comprises part of beams in the inference beam set.
